(19) United States
(12) Patent Application Publication
(10) Pub. No.: US 2002/0188564 A1
(43) Pub. Date: Dec. 12, 2002

(54) SYSTEM AND METHODS FOR DEPOSITING FUNDS TO A FINANCIAL SERVICE PROVIDER

(76) Inventor: BARRY L. STAR, WINCHESTER, MA (US)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 09/309,073

(22) Filed: May 10, 1999

(51) Int. Cl. G06F 17/60

(52) U.S. Cl. 705/42

(57) ABSTRACT

A method is presented to deposit funds into a financial service provider, such as a securities company, via a banking institution. A client first deposits funds into a transfer account at the banking institution using a deposit slip that can include a magnetic ink character reading (MICR) line. The MICR line includes the number associated with the client's account and the number of the transfer account. The service provider uses a software package to accept data from the banking institution informing it of the client's name, account number, deposit size, etc. The banking institution then transfers the funds from the transfer fund to the service provider's clearing firm. This firm, at their convenience, may then transfer the funds to the financial service provider's general ledger account. Three business days after the initial deposit, the service provider finally credits the client's account the amount of the deposited funds.

### FIELD OF THE INVENTION

This application relates to financial services and more particularly presents systems and methods of delivering funds to an online banking service.

### BACKGROUND OF THE INVENTION

Recent developments in networking technology and distributed computing have made possible the development of tools that allow individuals and companies to manage their money with greater efficiency and accuracy. For example, on-line banking services allow companies and people to make transactions during off-hours, and to monitor more closely account balances and the status of transactions, such as whether a check has cleared or whether a wire-transfer has arrived. These new tools and services hold a promise to provide individual businessmen and small companies with the same control over their finances as larger companies can afford with in-house accounting departments. Such control is of great value to a young company, when the proper control of company finances can mean the difference between success and failure.

However, for these new financial services to succeed, they must be able to provide customers with reliable and consistent service. Today, for any financial service provider, such as commercial banks, mutual fund providers, and brokerage houses, providing outstanding services to its clients is of paramount concern. In the present world market, it is not enough to offer the qualities traditionally associated with first-class banks. While attributes like security, and reliability continue to be important, these are necessary but not sufficient conditions for a financial service provider to be successful. Customers today expect convenient access to such service providers, and once there, they demand quick service.

A particular problem for many on-line financial services is how to efficiently accept deposits of funds from clients. While some nationwide commercial banking services can meet this challenge by offering ubiquitous bank branches for accepting deposits and by providing rapid access to their clients' money, other financial service providers like brokerage houses, mutual fund providers and online banking services, for example, have lagged behind. It is not difficult to understand why. Unlike commercial banks, these types of service providers cannot have “a branch in every corner” to permit clients to make deposits into their accounts.

Many financial service providers, such as brokerage houses, that do not have an extensive network branch of offices, require that customers mail funds through the post, or keep an account at the institution or maintain a credit line at the institution. Thus, to have sufficient funds available in a securities account to make a transaction, for example to deposit funds received on an invoice into an account for making a payroll, or to deposit funds for making a trade, a client may have to rely on the postal service to deliver a check to his financial service provider. Needless to say, the length of time required to get the funds into his account may preclude the execution of a desirable trade. Furthermore, it is inconvenient to have to send cash by mail every time a deposit cannot be made personally to the financial service provider. Similarly, it is not always realistic to expect a small company to maintain at any institution a deposit that is as large as a month's payroll.

Thus, there is a need for improved systems and methods that can allow a client to efficiently and reliably deliver funds into an account at a financial institution, such as an on-line financial service institution.

### SUMMARY OF THE INVENTION

The invention addresses the aforementioned problems by making use of a network of commercial institutions, such as banks, credit unions, check cashing services, money order providers, wire transfer services or any other such institution, to deposit funds into a financial service provider. The above-mentioned client need only be close to a participating banking institution's branch to be able to deposit funds into his financial service provider's securities account. He may avail himself of most of the conveniences offered by the participating banking institution to get funds to his financial service provider regardless of the actual location of this service provider.

In particular, a client wishing to deposit funds at a financial service provider proceeds to a participating banking institution and makes a deposit into a transfer account for the benefit of customers. This deposit can be made with an encoded deposit slip and, if the funds include checks, an endorsement stamp. In the evening of the deposit day, the banking institution can process the deposit. The financial service provider that will receive the funds receives notice of the deposit and the identity of the depositor via a data file, such as, for example, a Bank Administration Institute (BAI)-formatted file download or other type of file download. The service provider's software can then issue a credit for the deposited funds, such as on the third business day after the deposit was made, and transfer the funds from the transfer account to the service provider's clearing firm. Finally, the clearing firm transfers the funds from their banking institution account to the financial service provider's general ledger account.

More specifically, methods are presented for allowing a client to deposit funds to a financial service provider through an intermediate banking institution. The methods include providing the funds and a deposit slip to the intermediate banking institution, the slip having an associated client account number of the financial service provider that identifies the client, and a transfer account number that designates a transfer account to which the funds are deposited; transmitting data that includes the account numbers from the banking institution to the financial service provider; crediting an account of the client at the financial service provider; and transferring the funds from the transfer account to an account belonging to a clearing firm wherein the funds are made available to the financial service provider.

In one embodiment of the present invention, the act of transmitting data includes transmitting a daily file download of Bank Administration Institute files having activities of a business day. In another embodiment, an endorsement stamp is provided by the financial service provider to endorse funds that are checks. The endorsement stamp may include a statement indicating that the check is for deposit only, the name of the financial service provider, the transfer account number, the name of the client, and the associated client account number.

In other embodiments of the present invention, crediting the client's account at the financial service provider occurs on the third business day after the client deposits the funds at the intermediate banking institution; transferring the funds occurs after the funds have been collected from the client; the method further comprises transferring funds from the clearing firm to a general ledger account of the financial service provider; and tracking the flow of the funds by the client proceeds on the World Wide Web using an Internet.

In another embodiment of the present invention, a method for allowing a client to deposit funds to a financial service provider through an intermediate banking institution is presented. The method includes providing a number associated with a location code that permits the client to make deposits into a transfer account at the intermediate banking institution; transmitting data that includes the number associated with the location code from the intermediate banking institution to the financial service provider; crediting the client's account at the financial service provider after reading the data; and transferring the funds from the transfer account to an account belonging to a clearing firm of the financial service provider. The embodiment may further include transferring the funds from the account belonging to a clearing firm to a general ledger of the financial service provider.

Also presented herein are systems for allowing a client to deposit funds to a financial service provider through an intermediate banking institution. Such a system can include a deposit slip provided to the client, said slip having an associated client account number to help identify the client; a transmitter of data including an amount of the funds, the associated client account number, and a transfer account number to send the data from the intermediate banking institution to the financial service provider alerting the financial service provider of a pending deposit; and a clearing firm having an account into which the funds may be transferred from a transfer account.

The associated client and transfer account numbers may be provided on a magnetic ink character reading line. The system may further include a general ledger account into which the funds may be transferred from the clearing firm, and a tracker for the client to track a flow of the funds. The tracker may include an Internet to permit the client to transmit and receive information regarding the funds. A Bank Administration Institute (BAI) file may be utilized to transmit data from the banking institution to the financial service provider.

Also described herein are methods executed in a computer system for allowing a client to deposit funds to a financial service provider through an intermediate banking institution. Such methods can include the acts of reading a file received from the intermediate banking institution to determine an amount of the funds that is deposited by the client and an account number that helps identify the client; storing data that includes the deposit amount and account number into a data base; processing data from the database to schedule a transfer of the funds from a transfer account at the intermediate banking institution to an account of a clearing firm; transmitting data from said database to the clearing firm to transfer the funds from an account of the financial service provider to an account of the client; and transmitting data from the database to the clearing firm to transfer the funds from the account of the clearing firm to an account of the financial service provider.

### BRIEF DESCRIPTION OF DRAWINGS

The following figures depict certain illustrative embodiments of the invention in which like reference numerals refer to like elements. These depicted embodiments are to be understood as illustrative of the invention and not as limiting in any way.

In FIG. 1 is illustrated a flowchart indicating the steps invoked to permit a client to deposit funds at a financial service provider via an intermediate banking institution.

FIG. 2 shows a flowchart depicting the steps involved as a client deposits money into a banking institution for having those funds reach a financial service provider, such as a securities firm.

FIG. 3 is an example of a BAI file associated with a deposit.

FIG. 4 depicts the flow of data that can occur during the transfer of funds from the client to a financial service provider via a banking institution.

FIG. 5 depicts a deposit slip for a client to deposit funds to a banking institution.

FIG. 6 depicts a screen shot of an Internet display showing information that a client could track after making a deposit.

### DETAILED DESCRIPTION OF THE ILLUSTRATED EMBODIMENTS

The materials and processes according to the invention will now be explained with reference to certain illustrated embodiments, and in particular to certain illustrated embodiments that can be employed as systems and methods of depositing funds at a financial service provider by using the services offered at a banking institution. The depositing of funds may proceed by providing an accompanying deposit slip to the banking institution for allowing a client to deposit funds, said slip including the financial service provider's associated client account number and a transfer account number, and when the funds are checks, endorsing the checks by using an endorsement stamp provided by the financial service provider, or the banking institution. These systems and methods can include the depositing of funds into an account at a securities firm via an intermediate banking institution by using software and files consistent with the Bank Administration Institute's protocol.

However, the invention is not to be limited to the embodiments described and depicted herein, but instead it will be realized that the invention embodies many alternative systems and methods, as well as many alternative software packages and files that can employ the methods and systems described herein. For the purposes of illustrating the invention, the systems and methods described herein will be explained with reference to depositing of cash or checks into an account at a securities firm via a bank with a waiting period of three business days between the time that the client deposits the funds and the time that the client obtains a corresponding credit in his account. However, other methods, systems, and applications are readily seen by those of ordinary skill in the art.

Such alternative methods, systems, and applications can include those wherein funds are to be deposited into a financial service provider with an arbitrary waiting period and in particular, any method, system, or application for depositing funds to a financial service provider via an intermediate financial service provider, or multiple intermediate financial service providers. These alternative systems, methods, or applications can include, without limitation, those for transferring information or possessions from a client to a financial service provider via a third party. Moreover, a client can refer to an individual, group of individuals, company, or other entity.

A realization of the present invention is that a deposit service for franchise operations at some banks that can serve as a useful paradigm for systems and methods for depositing funds at a financial service provider via an intermediate banking institution. Franchises with numerous locations throughout a region of the country may transfer funds to a central depository account set up by the headquarters of the franchise operation. Every franchisee, or a portion of the franchisees, would receive an endorsement stamp and deposit slip to allow them to make deposits to this central depository account. At headquarters, a Bank Administration Institute (BAI) file would be received indicating the funds deposited by the various franchisees. Each franchisee can be identified by a unique location code. When a new franchise opens, the franchise headquarters can secure from the bank a new location code that is assigned to the new franchise to permit deposits into the central depository account.

In the present invention, such a deposit service is exploited as a system and method for depositing funds by a client via a banking institution. Each client can be assigned a number associated with a location code that permits the client to make deposits into a transfer account. This location code may be provided to the financial service provider by the banking institution to which the deposit is initially made. The number of digits in the associated number depends on whether the location code has sufficient digits: in one embodiment, the number associated with the location code is either identical to the location code if it has at least eight digits, or is a different eight digit number if the location code has less than eight digits.

The above description will now be illustrated by reference to the accompanying drawings. Referring to FIG. 1, a flowchart indicates the steps invoked to permit a client to deposit funds at a financial service provider via a banking institution. In the first step 1, the financial service provider requests a new location code for a new client. In the second step 2, the banking institution assigns a unique location code to each client. In the third step 3, a decision is made regarding whether or not there are enough digits in the location code provided by the banking institution. If the answer is affirmative, a fourth step 4 is taken wherein the number associated with the client making the deposit is taken to be identical to the location code. If the answer is negative, a fifth step 5 is taken wherein the number associated with the client is taken to correspond to, but be different than, the location code. In the final step 6, the financial service provider provides the client with an endorsement stamp and deposit slip having the associated client account number.

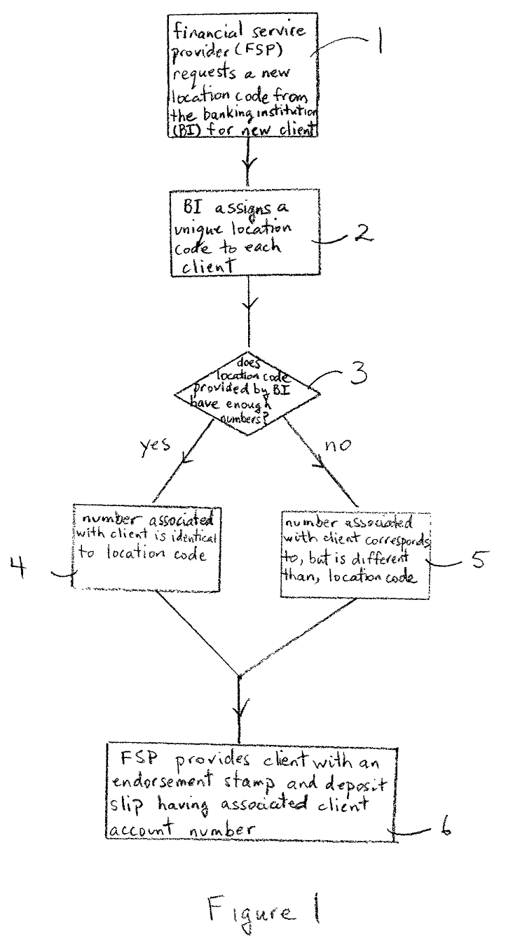

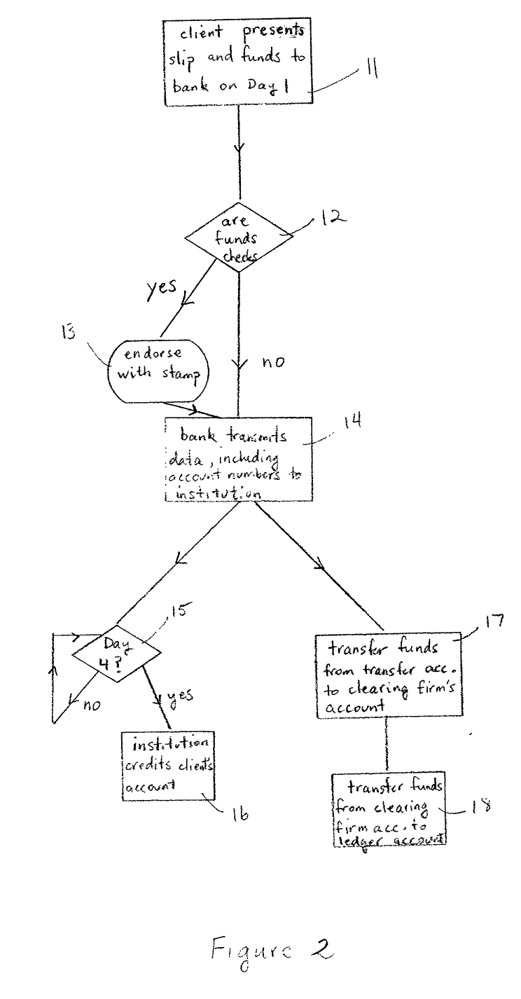

The process depicted in FIG. 2 can be implemented as a computer program operating on a data processing platform that can optionally include a connection to a data network for communicating over a network, such as a TCP/IP network, or any other suitable network. The data processing system can be a conventional data processing platform such as an IBM PC-compatible computer running the Windows operating systems, a Sun workstation running a Unix operating system, a PDA device or any other suitable platform. Alternatively, the data processing system can comprise a dedicated processing system that includes an embedded programmable data processing system that can implement the functions depicted in FIG. 2. Such a system can be realized as an automatic teller machine, having a keypad data entry system, a deposit receipt system, and optionally, access to a data network to allow a customer to view account balances at an on-line financial service institution. The computer program for implementing the process can be implemented as a C-language computer program, or a computer program written in any high level language including Fortran, Java or basic. General techniques for such high level programming are known, and set forth in, for example, Stephen G. Kochan, Programming in C, Hayden Publishing (1983).

FIG. 2 shows a flowchart depicting the steps involved in one exemplary process that allows a client to deposit money into a banking institution in a manner that has the funds reach a financial service provider. A method for sending funds to a financial service provider will be described using an example in which a client makes a deposit to a financial service provider, such as a securities firm called Securities, Inc., by using the services of a bank. In step 11 of the method, the client goes to a bank on day one to make a deposit. The client can include an individual or a company, or any other suitable entity. The deposit is put into an account entitled:

### Securities, Inc.

### Transfer Account for the Benefit of Customers

Alternatively, instead of “Transfer Account for the Benefit of Customers,” the account may be entitled, “Transfer Account for the Benefit of Clients,” “Special Transfer Account FBO Customers,” or some combination thereof. Administratively, there is one transfer account for a predefined set of depositors. Although sharing this account, individual depositors are identified by a number associated with a unique location code. The deposit is made using items provided to the client by either Securities, Inc., or the bank. These items include a deposit slip having the associated client account number at Securities, Inc., and the transfer account number in a magnetic ink character reading (MICR) line. A device at the bank then reads the MICR line, and deposits the client's funds into the correct transfer account. Next, the bank transmits to Securities, Inc. the amount of the deposit and the associated client account number at Securities Inc.

In step 12, a determination is made as to whether part or all of the deposit is to be made with checks. Checks are endorsed in step 13 using an endorsement stamp, which like the deposit slip can be provided to the client by Securities, Inc., or the bank. In one example, the stamp could read:

For Deposit Only
Securities, Inc.
Transfer Account FBO Customers
Bank Account # 12345678
John A. A., Inc.
Location Code: # 88888888

FBO is an acronym for “For the Benefit of,” John A. A. is a hypothetical client, and the location code is associated with the client's Securities, Inc. account number. This endorsement stamp is used for the deposit when a determination is made in step 12 that part or all of the funds to be deposited are comprised of checks. In a preferred embodiment, the check is endorsed while making the deposit. However, in another embodiment, the check could be endorsed before presenting the funds for deposit.

The bank then processes the deposit. In step 14, the bank sends a data transmission, which Securities Inc. receives and processes using a software package. The process retrieves the client's associated number, determines which clients made deposits, and assesses the amount of those deposits from the transmitted data. This software package also triggers several of the steps outlined below.

In step 15, the process determines whether it is day four, given that the original deposit was made on day one.

If the answer is affirmative, the process proceeds to step 16 in which the process credits the deposit to the client's Securities, Inc. account. The three business day time difference between the initial deposit and this last mentioned credit allows time to collect the deposited funds.

In the parallel step 17, the process prompts a transfer of the deposited funds from the transfer account to an account at either the bank holding the transfer account or at another bank belonging to the clearing firm for Securities, Inc. The clearing firm is an office where the bank exchanges checks and drafts and settles accounts. The transfer takes place once the deposit is collected. Securities, Inc. thus acts as the introducing company to the clearing firm.

In the final step 18, the clearing firm moves the money from their bank account to Security Inc.'s general ledger account at their convenience. The credit to the client's account results in a corresponding debit to Security Inc.'s general ledger account at the clearing firm. The transfer of funds debits the transfer account and credits the Securities Inc.'s general ledger account.

Part of the software employed to process data pertaining to the deposit transaction can be provided by the banking institutions. The service includes access to the relevant files indicating the transactions of the financial service provider's clients. This software has its own internal scheduler and might be developed by a third party. Securities Inc. can run a daily file download of BAI files containing the previous day's activities. In one example, these files can be received at 6:00 a.m.. Thirty to forty-five minutes later, an internal process reads these files and copies relevant information onto a database at Securities, Inc. Securities, Inc. can then make internal adjustments or general ledger entries that are then forwarded daily to the clearing firm three business days after the deposit has been made. These entries facilitate the transfer of funds from Securities Inc.'s general ledger account to the client's account. The clearing firm can provide record layouts so that data is in a format that can be anticipated by Securities, Inc. software. Because each banking institution may assign different codes and locations in the BAI files for the same transactions, some analysis by someone of ordinary skill in the art may be necessary to ascertain what transaction corresponds to what code.

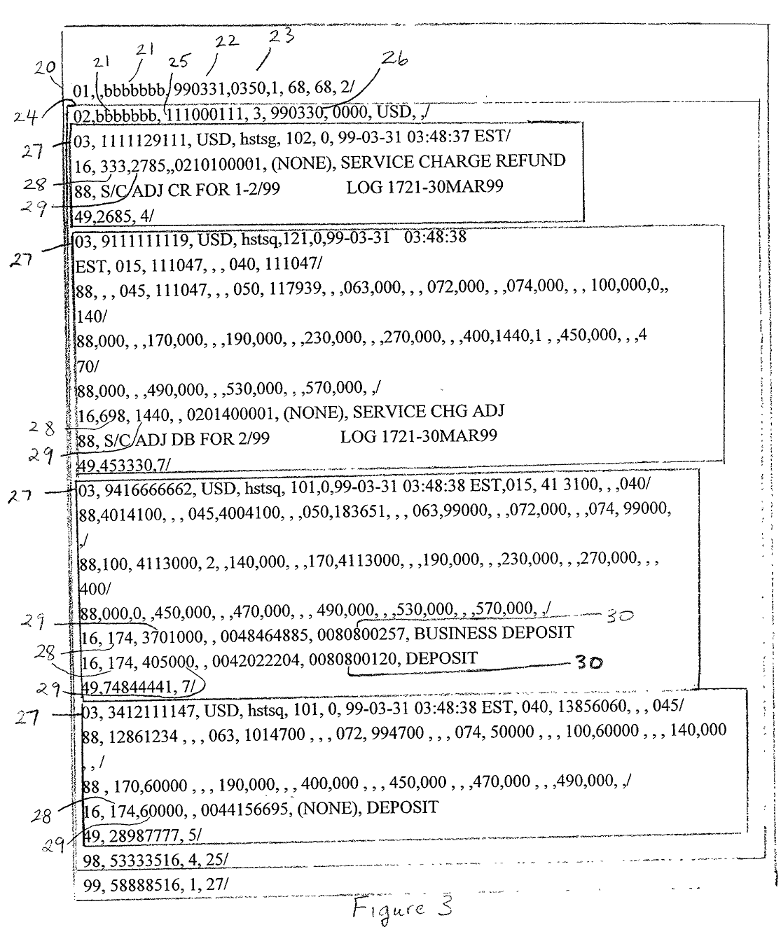

FIG. 3 is an example of a BAI file associated with a deposit. The “01” designation marks the beginning of a file section 20, and the “99” is indicative of a file terminator. The file includes a bank identifier 21, a date the file was created 22, and the number of records in the file 23. The “02” designation marks the beginning of a group section 24, and the “98” is indicative of a group terminator. The group includes a bank routing number 25, and the business date of record 26. The “03” designation marks the beginning of an account section 27, and the “49” is indicative of an account terminator. One account is provided for each relevant account at the banking institution belonging to the financial service provider. Of the four accounts sections of FIG. 3, two pertain to operating accounts, and one is not currently processed; in the future, at least one of the account sections could be used for reconciliation of data. The 88 lines indicate that they are continuations of the previous line. Lines beginning with a “16” have as a first entry the transaction code 28 indicating the type of transaction to which the file pertains. This transaction code 28 is usually peculiar to a specific banking institution. The third entry is the amount of the deposit 29, with the last two digits being decimal points. The fifth entry is a location code 30 that is associated with a client account number.

The BAI file detailed in the previous paragraph is obtained by the financial service provider from the banking institution at which the client made a deposit. This file allows the financial service provider to determine who deposited the funds and the amount of those funds. This information is needed to initiate the process outlined in FIG. 2.

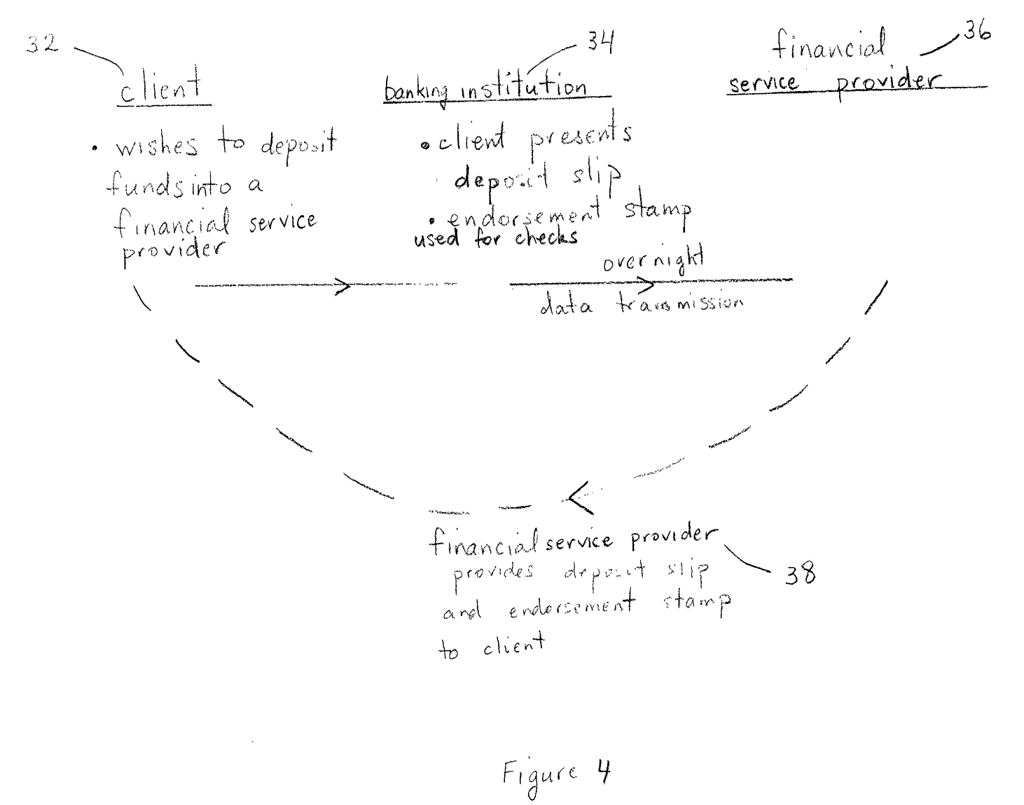

In FIG. 4 is shown the entities involved in the transfer of funds from the client to a financial service provider such as a securities firm, and the flow of materials required to effect that transfer. Element 32 of FIG. 4 represents the client. The client can include individual persons or companies. Element 34 of FIG. 4 represents the banking institution, which refers to branches of participating banking institutions that are conveniently accessible to the client. The financial service provider 36 is the ultimate destination of the client's funds. The client endorses checks with an endorsement stamp, and submits a deposit slip to a branch of a participating banking institution. The slip and stamp are provided to the client by the financial service provider in a step labeled as element 38. In another embodiment, at least one of the slip and the stamp could be provided by the banking institution.

After a client 32 decides that he wishes to make a deposit to his financial service provider 36, he must decide how the funds are going to be transferred. Traditionally, one of the only options available would have been to send the funds by mail. With the present invention, a more convenient method is possible as is illustrated in FIG. 4. The client 32 chooses a participating banking institution 34 of his choice that will transfer the funds to the financial service provider 36. After the funds are deposited by the client with the help of a deposit slip, and, if a check, an endorsement stamp, the banking institution 34 alerts the financial service provider 36 of the pending deposit via an overnight transmission. The step of providing the client with deposit slips and endorsement stamps 38 ensures that the client has an adequate supply to continue making deposits.

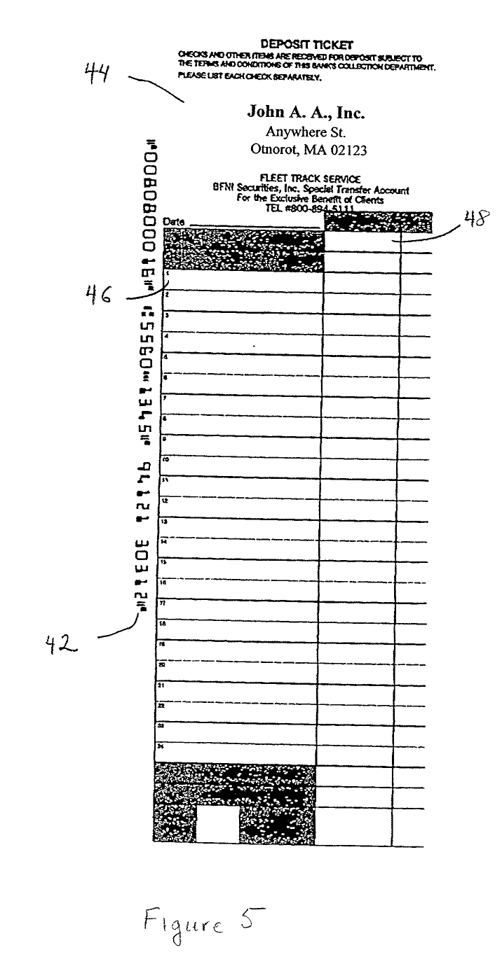

FIG. 5 depicts one example of a deposit slip required for a client to deposit funds to a banking institution with the ultimate aim of having the funds transferred to his financial service provider. The deposit slip has a number that is associated with the client's Securities Inc. account and a number of the transfer account in a magnetic ink character reading (MICR) line labeled as element 42. John A. A., Inc. is the client 44 making the deposit. The field 46 is provided to insert descriptive information about the deposit, whose amount is inserted in field 48.

It is understood that a deposit slip need not be a piece of paper. Instead, a deposit slip can include any conveyor of information, such as magnetic cards, tapes, storage media, or other such items, electronic or otherwise.

In a preferred embodiment of the invention, the client would be able to track his funds on the World Wide Web on the Internet as they move from the banking institution's branch at which the deposit was first made to his or her own account at Securities, Inc. Information that might be gleaned from the Internet includes account balance and pending deposits.

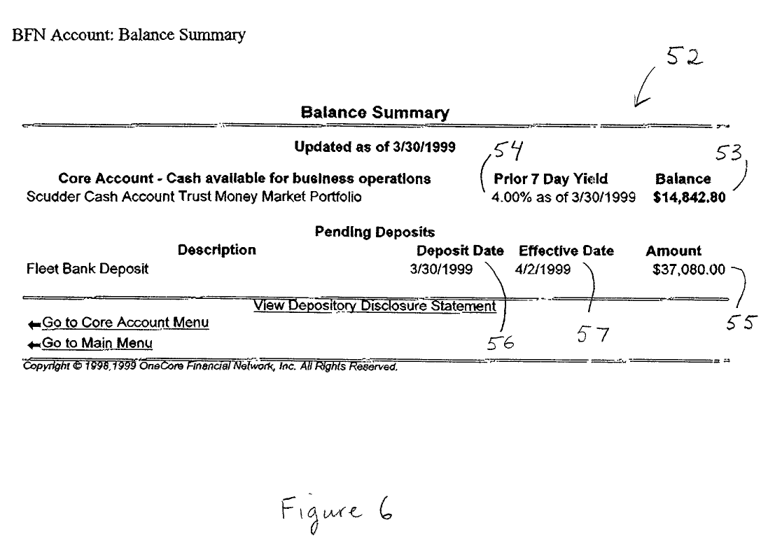

In FIG. 6, a screen shot of an Internet display 52 is shown showing information that a client could track after making a deposit. The design and development of web pages that can include such a display follows from principles well known to those of skill in the art, including principles described in detail in Ian Graham, HTML Source Book, John Wiley (1997). The balance 53, and prior seven day yield 54 are shown. Also shown is the amount of the pending deposit 55 that will become available on the fourth business day from the initial deposit date. The actual deposit date and the effective date on which the deposit is credited to the account at the financial service provider are shown as elements 56 and 57, respectively.

After proceeding to a banking institution with the aim of ultimately depositing funds at another financial service provider and making a deposit into a transfer account, a client may wish to track the deposit on the World Wide Web. For this purpose, a client may use a password issued to him by the financial service provider to log into his personal account information site. If a client makes a deposit at a banking institution, the financial service provider may be notified the next morning. This service provider then discloses this transaction as a pending deposit 55 on the personal account information site on the World Wide Web until such time as the pending deposit 55 is credited to the client's account and the client is able to freely use those funds. On the personal account information site, the deposit date 56 on which the client deposited the funds, and the effective date 57 when the deposit will be credited to the client's account at the financial service provider is exhibited. In one embodiment, if deposits are made to the banking institution using different deposit slips, these will be manifest on the personal account information site as individual pending deposits; however, if more than one deposit is made with the same deposit slip, the different deposits will not be itemized, but instead a pending deposit for the total amount will be exhibited. In another embodiment, what type of deposit is made, i.e., if it is in checks or cash, is not detailed on the personal account information site.

Another piece of information that can be gleaned from the personal account information site is the prior seven day yield 54, which is the yield on the client's money market that is the core fund. (In the example of FIG. 6, the particular money market is a Scudder Cash Account Trust Money Market.) The balance 53 pertains to this same money market account.

While the invention has been disclosed in connection with the preferred embodiments shown and described in detail, various modifications and improvements thereon will become readily apparent to those skilled in the art. Accordingly, the spirit and scope of the present invention are to be limited only by the following claims.

I claim:

1. A method for allowing a client to deposit funds to a financial service provider through an intermediate banking institution, comprising
providing the funds and a deposit slip to the intermediate banking institution, said slip including an associated client account number of the financial service provider that identifies the client, and a transfer account number that designates a transfer account to which the funds are deposited;
transmitting data that includes the account numbers from the banking institution to the financial service provider;
crediting an account of the client at the financial service provider; and
transferring the funds from the transfer account to an account belonging to a clearing firm wherein the funds are made available to the financial service provider.

2. A method for allowing a client to deposit funds to a financial service provider through an intermediate banking institution as in claim 1, wherein transmitting data includes transmitting a daily file download of Bank Administration Institute files having activities of a business day.

3. A method for allowing a client to deposit funds to a financial service provider through an intermediate banking institution as in claim 1, further comprising
determining whether the funds are checks; and
when the funds are checks, endorsing the checks by using an endorsement stamp.

4. A method for allowing a client to deposit funds to a financial service provider through an intermediate banking institution as in claim 3, wherein endorsing the checks by using an endorsement stamp includes using an endorsement stamp indicating that the check is for deposit only, the name of the financial service provider, the transfer account number, the name of the client, and the associated client account number of the financial service provider.

5. A method for allowing a client to deposit funds to a financial service provider through an intermediate banking institution as in claim 1, wherein the associated client and transfer account numbers are provided on a magnetic ink character reading line.

6. A method for allowing a client to deposit funds to a financial service provider through an intermediate banking institution as in claim 1, wherein crediting an account of the client at the financial service provider occurs on a third business day after the client deposits the funds at the intermediate banking institution.

7. A method for allowing a client to deposit funds to a financial service provider through an intermediate banking institution as in claim 1, wherein transferring the funds occurs after the funds have been collected from the client.

8. A method for allowing a client to deposit funds to a financial service provider through an intermediate banking institution as in claim 1, further comprising transferring funds from the clearing firm to a general ledger account of the financial service provider.

9. A method for allowing a client to deposit funds to a financial service provider through an intermediate banking institution as in claim 1, further comprising tracking a flow of the funds by the client on an Internet.

10. A method for allowing a client to deposit funds to a financial service provider through an intermediate banking institution as in claim 9, wherein tracking a flow of the funds by the client on the Internet includes tracking a pending deposit.

11. A method for allowing a client to deposit funds to a financial service provider through an intermediate banking institution, comprising
providing a number associated with a location code that permits the client to make deposits into a transfer account at the intermediate banking institution;
transmitting data that includes the number associated with the location code from the intermediate banking institution to the financial service provider;
crediting the client's account at the financial service provider after reading the data; and
transferring the funds from the transfer account to an account belonging to a clearing firm of the financial service provider.

12. A method for allowing a client to deposit funds to a financial service provider through an intermediate banking institution as in claim 11, further comprising
transferring the funds from the account belonging to a clearing firm to a general ledger account of the financial service provider.

13. A system for allowing a client to deposit funds to a financial service provider through an intermediate banking institution comprising
a deposit slip provided to the client, said slip having an associated client account number to help identify the client;
a transmitter of data including an amount of the funds, the associated client account number, and a transfer account number to send the data from the intermediate banking institution to the financial service provider alerting the financial service provider of a pending deposit; and
a clearing firm having an account into which the funds may be transferred from a transfer account.

14. A system for allowing a client to deposit funds to a financial service provider through an intermediate banking institution as in claim 13, further comprising a stamp to endorse funds that are checks.

15. A system for allowing a client to deposit funds to a financial service provider through an intermediate banking institution as in claim 13, wherein the associated client and transfer account numbers are provided on a magnetic ink character reading line.

16. A system for allowing a client to deposit funds to a financial service provider through an intermediate banking institution as in claim 13, further comprising means for crediting an account of the client at the financial service provider, said means including a software package to credit a correct amount on a prescribed day.

17. A system for allowing a client to deposit funds to a financial service provider through an intermediate banking institution as in claim 13, further comprising a general ledger account into which the funds may be transferred from the clearing firm.

18. A system for allowing a client to deposit funds to a financial service provider through an intermediate banking institution as in claim 13, further comprising a tracker for the client to track a flow of the funds, said tracker comprising an Internet to permit the client to transmit and receive information regarding the funds.

19. A system for allowing a client to deposit funds to a financial service provider through an intermediate banking institution as in claim 13, further comprising a Bank Administration Institute file by which data may be transmitted from the intermediate banking institution to the financial service provider.

20. A method executed in a computer system for allowing a client to deposit funds to a financial service provider through an intermediate banking institution comprising
reading a file received from the intermediate banking institution to determine an amount of the funds deposited by the client and an associated account number that helps identify the client;
storing data that includes said amount and account number into a database;
processing data from said database to schedule a transfer of the funds from a transfer account at the intermediate banking institution to an account of a clearing firm; and
transmitting data from said database to the clearing firm to transfer the funds from an account of the financial service provider to an account of the client.

21. A method executed in a computer system for allowing a client to deposit funds to a financial service provider through an intermediate banking institution as in claim 20, further comprising
transmitting data from said database to the clearing firm to transfer the funds from the account of the clearing firm to the account of the financial service provider.
